(19) United States
(12) Patent Application Publication
(10) Pub. No.: US 2017/0202189 A1
(43) Pub. Date: Jul. 20, 2017

(54) AQUARIUM SYSTEM FOR ALL-AROUND VIEWING AND MICROCLIMATE SIMULATION

(71) Applicant: Keahi J. Chun, Honolulu, HI (US)

(72) Inventor: Keahi J. Chun, Honolulu, HI (US)

(21) Appl. No.: 15/000,248

(22) Filed: Jan. 19, 2016

(51) Int. Cl. A01K 63/04; A01K 63/00; A01K 63/06; C02F 3/00; C02F 1/28

(52) U.S. Cl. CPC A01K 63/047; C02F 3/00; C02F 1/283; A01K 63/065; A01K 63/006; A01K 63/06; A01K 63/042; A01K 63/045; C02F 2103/20

(57) ABSTRACT

An aquarium system for all-around viewing has a tank enclosure formed by optically transparent sides and a bottom plane, a sunken chamber below the tank for circulating water from and into the tank by a water circulation pump, water circulation outlet and inlet risers for circulating water flow from the tank into the sunken chamber and back into the tank, and a base on which the tank and sunken chamber are seated for containing electrical components for the aquarium system. The sunken chamber may be immersed within an outer pool of water to give the appearance of the tank enclosure floating on water. The base may hold various electrical and mechanical components for microclimate simulation, including magnetic induction drive for the water circulation pump and other motorized components; water spray pump to simulate rain; cooling pad; heating pad; temperature sensors; audio speakers; lighting controller; fog dispenser; and microprocessor for programmed control of desired microclimate simulations.

### FIELD OF INVENTION

This invention relates to improvements in aquarium design that enable unobstructed viewing of the contents of an aquarium on all sides around its tank. In a particularly preferred embodiment, the aquarium system enables user-selectable microclimate simulation of multi-faceted climate conditions in the aquarium.

### BACKGROUND OF INVENTION

Aquariums are well-loved for their aesthetic and pleasing qualities of allowing viewers to see fish and other aquatic life in a simulated watery environment. A typical aquarium is formed with glass sides forming a tank enclosure for holding a volume of water and various watery contents for viewing. Enthusiasts use aquariums to display watery environments populated with fish, invertebrates, amphibians, aquatic reptiles such as turtles, and aquatic plants. The term combines the Latin root “aqua”, meaning water, with the suffix “arium”, meaning “a place for”.

Other terms are also used to refer to variants of the general aquarium concept. A “vivarium” refers to an enclosure for various life forms including fish, animals and/or plants for observation or research. Often, a portion of the ecosystem for a particular species is simulated on a smaller scale, with controls for desired environmental conditions. A “paludarium” refers to a semi-aquatic enclosure simulating a rain forest, swamp or other wetland environment that includes both water and an atmosphere. The general term “aquarium” is used herein to refer to any enclosure that includes living and/or simulated contents displayed in a volume of water, whether filling the whole tank or partially, as the invention herein pertains to an improvement in aquarium design that enables unobstructed viewing of its contents on all sides by keeping the usual water circulation and filtration apparatus out of its view planes.

Since the water in an aquarium must be constantly filtered to remove debris and keep the chemical and bacterial composition of the water healthy for its living contents, a water filtering device and pump are typically placed outside the tank on one side and connected to water outflow and inflow tubes that are hung over the top edge of the side of the tank. Illumination lights may be mounted in a hood or top cover that is attached or straddled over the top edges of the tank. A key aesthetic disadvantage of the conventional aquarium layout is that the presence of the water filtering device, circulation pump, and water flow tubing alongside of the tank and/or hanging over the top of the tank obscures the viewing of aquarium contents on one or more sides of the tank. Even for viewing from non-obscured sides of the tank, the presence of tank apparatus and other mechanical structures in the view planes around the tank spoils the aesthetics of viewing the aquarium contents in their simulated watery environment.

This invention therefore has as its principal object to provide improvements in aquarium design that enable all-around viewing of the contents of the aquarium by keeping water circulation and filtering devices and other extraneous mechanical structures from obscuring viewing or otherwise spoiling the viewing aesthetics of the contents of the aquarium.

In the aquarium as well as the hydroponic or aquaponic industries, there is a great deal of attention and effort spent on creating simulated environments for various life forms, including but not limited to plants, moss, invertebrates, vertebrates, fungi, bacteria, etc. Not only are the functional needs important for aquariums and aquaponics, but the aesthetic beauty in presenting a simulation of natural life is also of great value. Providing clear visibility for an aesthetic, artistic arrangement of life forms, otherwise know as the aquascape, is of paramount importance for appreciation and appearance of the aquascaping art. The arrangement and placement of each plant and other items in the aquascape should have unobstructed viewing in order to enable full appreciation of the three-dimensional work of art. As part of the aquascaping art, simulations of climate conditions such as rain, lighting effects, and sound may be used to create “real life” effects.

Another principal object of the invention is to provide improvements in aquarium design for simulation of natural environments with sophisticated microclimate simulation components, such as rain, fog, temperature, lighting, sound and other effects, while ensuring that viewing is unobstructed on all sides by any required mechanical equipment so as to enhance the viewing aesthetics of the aquarium.

### SUMMARY OF INVENTION

In accordance with the above-described objects of the present invention, an aquarium system comprises:

a tank enclosure formed with contiguous sides of optically transparent material and a bottom plane for containing a volume of water therein;

a sunken chamber provided below the bottom plane of the tank enclosure for channeling a flow of water circulated from and back into the tank enclosure by a water circulation pump positioned within or adjacent to the sunken chamber;

a water circulation outlet riser for circulating water from the tank enclosure directly or indirectly into the sunken chamber below, and a water circulation inlet riser connected to the water circulation pump for circulation of water back into the tank enclosure above, wherein said water circulation outlet and inlet risers are made of optically transparent material; and

a bottom base on which the sunken chamber and tank enclosure are placed containing therein equipment for powering at least the water circulation pump positioned within or adjacent to the sunken chamber and other equipment for the aquarium system,

whereby the aquarium system enables viewing of aquarium contents arranged in the tank enclosure from all sides around the tank enclosure without any associated equipment obscuring viewing or otherwise spoiling the viewing aesthetics of the aquarium system.

In a preferred embodiment of the aquarium system, the sunken chamber is immersed within an outer pool having side walls and a bottom wall for containing a pool of water therein to be maintained near to a height position of the bottom plane of the tank above the sunken chamber, so that the aquarium contents arranged in the tank enclosure will appear to be floating on or surrounded by the water in the pool.

In a particularly preferred embodiment, the aquarium system is adapted for multi-faceted microclimate simulation for all-around viewing. The bottom base is configured for holding the associated equipment and electrical components for powering the various facets for microclimate simulation. The bottom base may contain or support one or more of the following components for microclimate simulation in the aquarium system:

1. A magnetic induction motor drive positioned in the base proximate the position of the water circulation pump within or adjacent to the sunken chamber.

2. A magnetic induction motor drive positioned in the base proximate a water spray pump within or adjacent to the sunken chamber for pumping a spray of water from the sunken chamber by a riser into the tank enclosure to simulate rain;

3. A cooling pad and heat sink in the base for cooling water in the tank enclosure by thermal contact with an underside of the sunken chamber and/or outer pool;

4. A heating pad in the base for heating water in the tank enclosure by thermal contact with an underside of the sunken chamber and/or outer pool;

5. One or more temperature sensors for sensing the temperature of water in the sunken chamber and/or outer pool;

6. Audio speakers positioned in the sides of the base for providing audible sounds for simulated environments in the aquarium system;

7. An array of LED lighting elements on an upper side of the base for directing illumination up the side walls of the tank enclosure, and a wireless transmitter in the base for transmitting control signals for controlling lighting elements arranged on or within a top cover placed on top of the tank enclosure;

8. A fog dispenser in the base for dispensing air with fog vapor into an air layer in the sunken chamber and to a fog inlet port into the tank enclosure;

9. A microprocessor in the base for providing programmed computerized control of component facets for microclimate simulation in the aquarium system; and

10. A data input to the microprocessor for selecting a stored microclimate simulation program to be used in the aquarium system and/or for inputting external data via an Internet or wireless connection for microclimate simulation in the aquarium system.

Other objects, features, and advantages of the present invention will be explained in the following detailed description of a preferred embodiment with reference to the appended drawings.

### BRIEF DESCRIPTION OF DRAWINGS

FIG. 1 is a perspective view from one side of a preferred embodiment of an aquarium system in accordance with the present invention

FIG. 2 is an elevation view of the preferred embodiment of the aquarium system showing a water filtration module installed in a slot adjacent the sunken chamber.

FIG. 3 is a perspective view showing a top side of a base of the preferred embodiment of the aquarium system.

FIG. 4 is a perspective view showing the bottom side of the base of the preferred embodiment of the aquarium system.

FIG. 5 is a perspective view showing a top side of a modified version of a base for the aquarium system.

FIG. 6 shows the water circulation flow in the preferred embodiment of the aquarium system.

FIG. 7 illustrates an example circuit diagram for a microprocessor and electrical components used for microclimate simulation in the aquarium system.

### DETAILED DESCRIPTION OF PREFERRED EMBODIMENTS

In the following detailed description of the subject matter hereof, one or more preferred embodiments are illustrated with certain specific details of implementation. However, it will be recognized by one skilled in the art that many other variations and modifications may be made and/or practiced in analogous applications or environments. It should be noted that methods, procedures, components, or functions that are commonly known to persons of ordinary skill in the field of the invention are not described in detail herein so as avoid unnecessarily obscuring a concise description of the preferred embodiment.

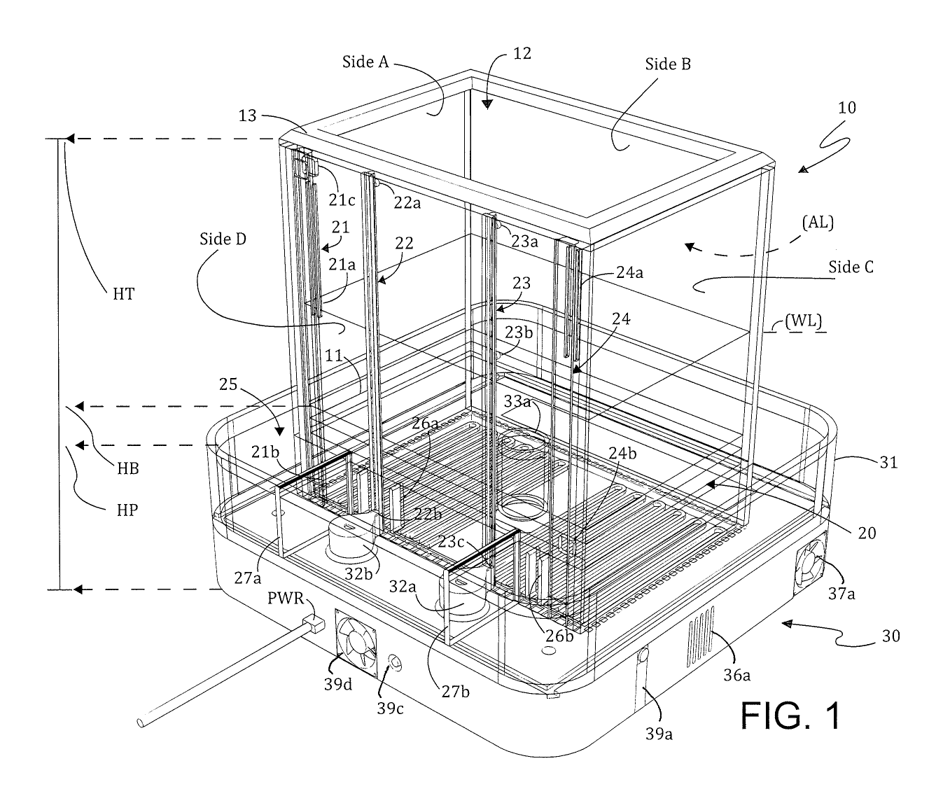

Referring to FIG. 1, a preferred embodiment of an aquarium system for all-around viewing is shown having a quadrangular-shaped tank enclosure 10 formed with four sides, i.e., Side A, Side B, Side C, and Side D. The tank may be formed in other configurations besides a quadrangular enclosure, such as a cylindrical, oval, or polygonal enclosure. The tank sides are made of durable, optically transparent material such as glass (silica), hard plastic (acrylic), or the like. The tank sides may be joined or otherwise formed contiguously at adjacent lateral edges and having a same vertical-standing height HT. Lower portions of the tank sides adjoin respective sides of a rectangular bottom plane 11, which defines a bottom surface for containing a volume of water and tank contents in the tank enclosure 10. The bottom plane 11 defines a bottom height level HB above which a viewer can view the tank contents in the watery environment in the tank enclosure 10 from all sides. Below the bottom plane 11 of the tank enclosure 10 is a sunken chamber 20 for handling water circulation from and back into the tank enclosure without obscuring any view planes from the sides around the aquarium system (to be described in further detail below). In the embodiment shown, the sunken chamber 20 is formed by lower extensions of the sides of the tank enclosure 10 extending below the height level HB of the bottom plane 11 down to a bottom wall for the sunken chamber 20. The sunken chamber 20 and tank enclosure 10 are seated on a bottom base 30 for containing electrical and mechanical equipment for the tank enclosure 10 and sunken chamber 20. The base 30 has an outer wall 31 standing upright on its upper side for forming (when filled with water) an outer pool 25 surrounding and in fluid communication with water in the sunken chamber 20. The outer pool 25 may be filled with water to a height HP, which is also the water height in the sunken chamber.

A removable top cover 12 may be used to cover the top of the tank enclosure 10, which in this embodiment is shown simply as a flat glass panel to also enable overhead viewing of the tank contents. Lighting for the tank enclosure may be arranged by an array of LED lighting elements exposed on an upper side of the base 30 for directing illumination up the side walls of the tank enclosure to light reflector elements housed in a four-sided housing 13 supported on the top cover 12. The LEDs emit directed light beams in-line with the light-transmissive walls of the tank enclosure 10 that hit the reflector elements in the housing 13 for reflection into the tank enclosure. The reflector elements may be angled or otherwise controlled by wireless control signals transmitted from a wireless transmitter in the base 30. Alternatively, other low-power LED lighting elements may be arranged in and powered by batteries in the housing 13 and controlled by control signals transmitted from a wireless transmitter in the base 30.

The volume of water to be contained in the tank enclosure 10 may be filled at or near the top vertical height HT or may be filled partway so as to leave an air layer or atmosphere layer AL. In this example, the tank enclosure is filled partway with water to a hypothetical waterline WL. The outer wall 31 on the base 30 for the outer pool 25 is shown formed with rounded corner and rounded edges, but of course may be formed in other configurations such as with square corners. The base is designed to sit on a flat surface of a table or a viewing platform.

The sunken chamber 20 provided below the bottom plane 11 of the tank enclosure 10 is designed for channeling a flow of water to be circulated out from the tank enclosure 10 for filtration and circulation around the outer pool 25 and back into the tank enclosure 10 using water circulation pump 32a. Another water spray pump 32b is provided for pumping water from the sunken chamber 20 to be sprayed as simulated rain into the air layer AL of the tank enclosure 10. The bottom plane 11 may be opaque or of a dark color to effectively conceal the sunken chamber 20 and its pump heads 32a, 32b from the view plane into the tank enclosure 10.

Mounted on one side (Side D) of the tank enclosure are a number of risers spaced apart from each other and having the vertical height HT to match that of the sides of the tank enclosure 10. The risers may be formed in tubular form (of round or square cross-section) and made of optically transparent material to have a minimum effect on the view plane from Side D into the tank enclosure 10.

A water circulation outlet riser 21 is arranged with a height-adjustable water level drain slot 21a for circulating water out from the tank enclosure 10 directly or indirectly into the sunken chamber. In the preferred embodiment shown, water drained by the water circulation riser 21 is channeled through a lower water circulation outlet 21b from the riser out into the surrounding outer pool 25 and around back into the sunken chamber 20. The water level drain slot 21a may be formed as a tubular sleeve with a slot aperture that is movable adjustably to user-selected incremental positions within a sleeve slot in the water circulation outlet riser 21. The level (bottom) of the water level drain slot 21a sets the waterline WL level in the tank enclosure 10. The air layer WL maintained above the waterline WL level enables simulation of combined air/water environments. Air outlet 21c is provided for air pressure equalization in the riser 21, and may also serve as an inlet for dispensing food into the tank enclosure.

A water spray riser 22 has a water spray inlet 22a at its uppermost portion for introducing a water spray into the air layer AL to simulate rain in the tank enclosure 10 as may be called for in a microclimate simulation. The water spray inlet 22a is provided for spraying pumped-up water in a rain-like shower into the tank enclosure 10. A bottom spray port 22b receives water pumped by the water spray pump 32b. In the preferred embodiment, the spray pump 32b may be of the type having a pump head driven by magnetic induction fields supplied by an induction generator in the base 30 below the sunken chamber 20, in order to keep minimize the presence of electrical and mechanical components in the viewer's view planes.

A water circulation inlet riser 23 has an upper water circulation inlet 23a and a lower water circulation inlet 23b for circulating water from the sunken chamber 20 back into the tank enclosure 10. The upper and lower water circulation inlets 23a and 23b ensure that incoming water can be mixed into the water volume in the tank enclosure 10 whether water is filled partway or to the full tank enclosure height HT. A bottom water circulation port 23c receives water pumped by the water circulation pump 32a for supply into the tank enclosure 10. The water circulation pump 32a may be of the type having a pump head driven by magnetic induction fields supplied by an induction generator in the base 30.

An air fog riser 24 has an air fog inlet 24a into the tank enclosure 10 at an uppermost portion thereof and an air fog port 24b at a lower portion just above the height HP of the water in the outer pool 25 and sunken chamber 20. The air fog port 24b receives air fog flow in an air layer maintained in the sunken chamber and fed by an extension pipe 33a extending from the base 30 into a receiving sleeve formed in the sunken chamber 20. Air fog flows from the end of the extension pipe 33a above the end of the sleeve into the air layer in the sunken chamber, where it flows into the air fog port 24b.

A fog generator is contained in the base 30 and may be of the commonly available commercial type that employs an ultrasonic mist-maker with an air compressor. In this type of fog generator, air is pressurized within the air layer of water tub by the compressor, and an opening allows for entry of CO2 gas from a canister to mix with the moisture-laden air and create fog vapor. The pressurized air with fog vapor is directed into the extension pipe 33a from the base and into the air layer in the sunken chamber 20. Air fog then rises up through riser 24 and into the tank air layer AL. The provision for providing fog vapor into the tank enclosure 10 may be offered as a premium option for microclimate simulation.

In this example of a preferred embodiment, the view planes into sides Side A, Side B, and Side C are clear of any water handling elements. The tank risers on Side D are optically transparent, and the water pumps and fog vapor feeds are located within or adjacent to the sunken chamber 20 below the bottom plane 11 of the tank enclosure 10 so as not to obstruct any view planes even from Side D. By keeping the water circulation elements below the height level HB of the bottom plane 11 of the tank enclosure 10, complete all-around viewing for the aquarium system is maintained without any overhang of tubing, wiring or mechanical devices to obstruct the viewer's view planes on any side. All electrical components are contained in the sealed base 30, and needs only a single power cord to be plugged into a PWR plug in the base.

The water in the sunken chamber 20 flows into and circulates around the outer pool 25. The water in the outer pool 25 is preferably maintained at a water height below the height HP of the outer wall 31 containing the outer pool, which is below the height HB of the bottom plane 11 of the tank enclosure 10 above the sunken chamber 20. This maintenance of the pool water height level below the bottom plane 11 creates an optical effect that the tank enclosure 10 will appear to be floating on or above the water in the pool.

The water circulation pump 32a and water spray pump 32b are positioned (for convenient maintenance) in the outer pool area spaced apart and aligned with their respective risers on the tank enclosure's side (Side D). Several pool circulation inlet slots 26a and circulation outlet slots 26b are provided for circulating water from the sunken chamber 20 to the outer pool area where the water circulation pump 32a is positioned. Water dams 27a and 27b extending from the pool wall 31 in the outer pool area form cheek walls to direct the flow of water. They are formed with a height lower than the height HP of the outer wall 31 of the pool in order to set a maximum pool water height by spillover of excess water to the water circulation pump 32a.

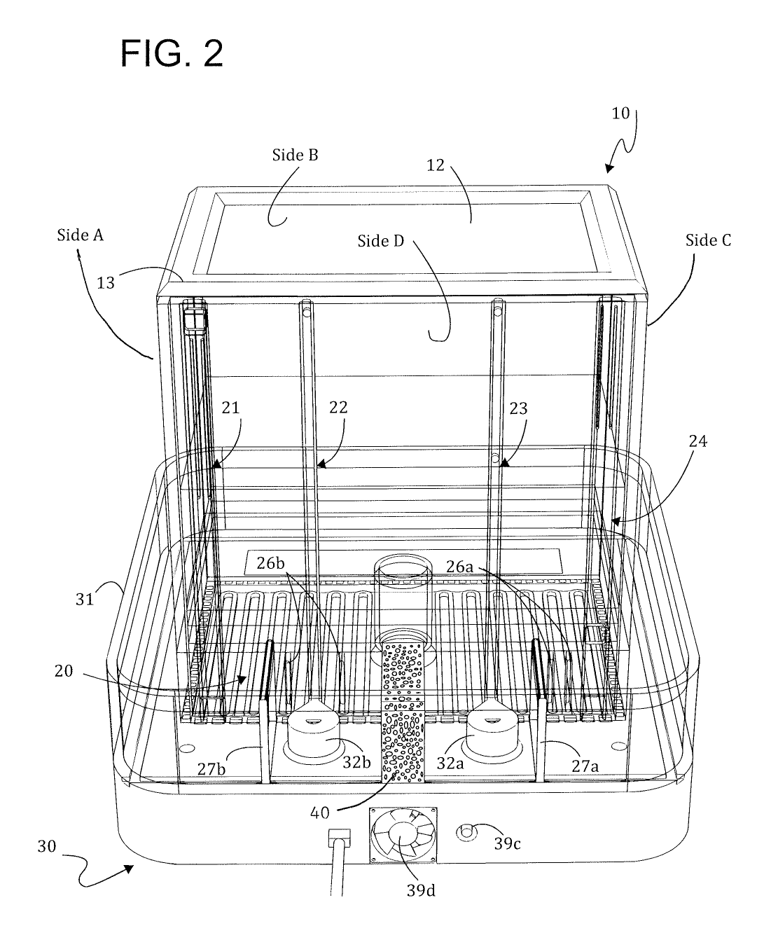

FIG. 2 is an elevation view showing a water filtration module 40 installed in the preferred embodiment of the aquarium system. The water filtration module 40 may be inserted between slot positions formed in the pool wall 31 in the outer pool area adjacent the water circulation pump 32a. The water filtration module 40 receives water flow from the sunken chamber 20 to the outer pool area through the circulation outlet slots 26b (left side of the figure), and directs the water flow through the filtration media in the module and the cleaned water flows to the water circulation pump 32a where it can be pumped up riser 23 into the tank enclosure 10. Biological filtration media such as porous sponge and/or simple activated carbon may be filled in the module. The filtration media typically does not need cleaning or replacement for months.

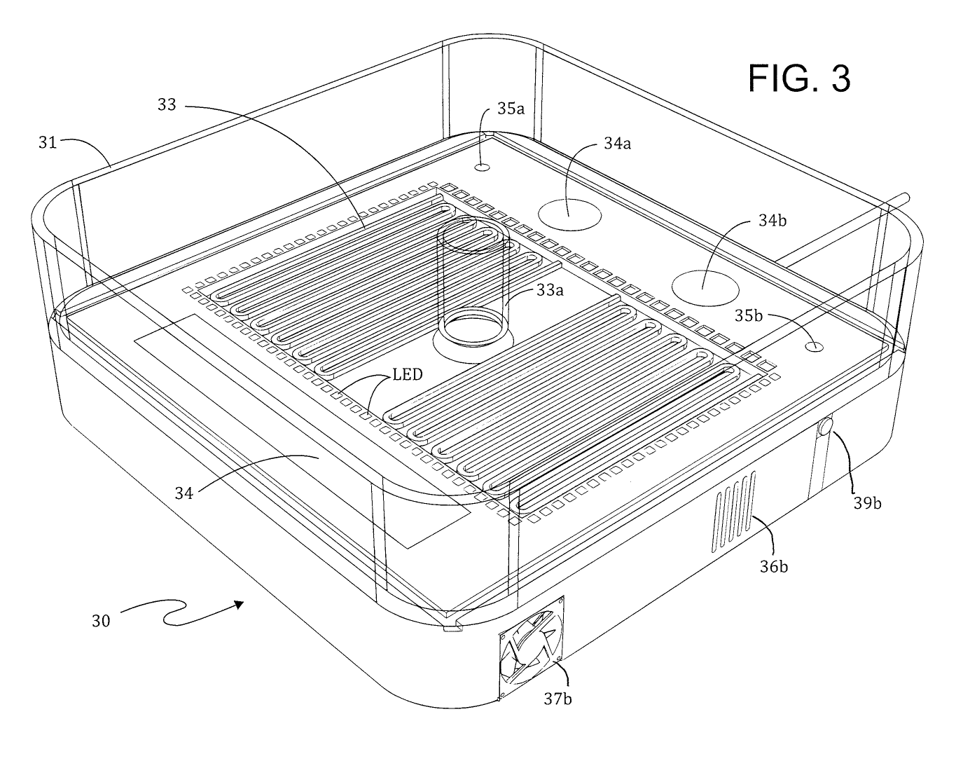

FIG. 3 is a perspective view of an upper side of the base 30 in the preferred embodiment of the aquarium system. The base 30 is formed with the surrounding outer wall 31 for the outer pool 25. The base may contain or support a number of electrical and/or mechanical components employed in the aquarium system, such as the following. On its upper surface on which the tank enclosure 10 and sunken chamber 20 are seated, the base has a heating pad 33 in its center portion positioned below the sunken chamber 20, an extension pipe 33a for air fog vapor, a cooling pad 34 (see heat sink 37 and fans 37a, 37b for cooling air flow) positioned to one side (Side B) below the outer pool 25, contact surfaces for magnetic induction motors 34a, 34b positioned (on Side D) below the water circulation pump 32a and the water spray pump 32b for driving them by magnetic induction, and water temperature sensors 35a, 35b. On opposite lateral sides of the base (Sides A and C) are positioned a pair of audio speakers 36a, 36b for playing sound themes for simulated environments.

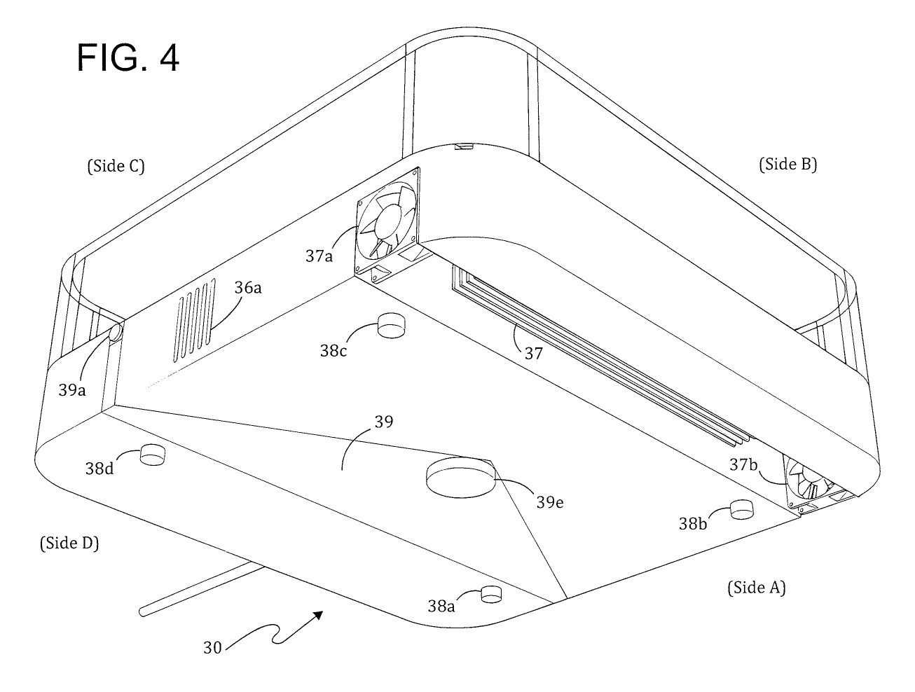

FIG. 4 shows the bottom side of the base 30 with heat sink 37 and fans 37a, 37b for supplying a cooling air flow for the cooling pad. Base pads 38a, 38b, 38c, 38d are mounted on the underside of the base and may be adjusted by 4-point leveling screws for leveling the base. The leveling screws may also be used to tilt the base to an inclined viewing angle if desired. Components for a fog generator contained in the base include supply holes 39a and 39b with removable rubber plugs for supplying a water tub for the fog generator, CO2 gas input port 39c, air compressor fan 39d, and a recessed portion 39e of the water tub.

The base is designed to contain all electrical and mechanical components for the aquarium system in a sealed container below the outer pool, sunken chamber and tank enclosure, so that any danger of electrical shock is avoided and complete, all-around viewing for the aquarium system is maintained without any overhang of tubing, wiring or mechanical devices to obstruct the viewer's view planes on any side. Other electrical components as desired may also be incorporated with the base.

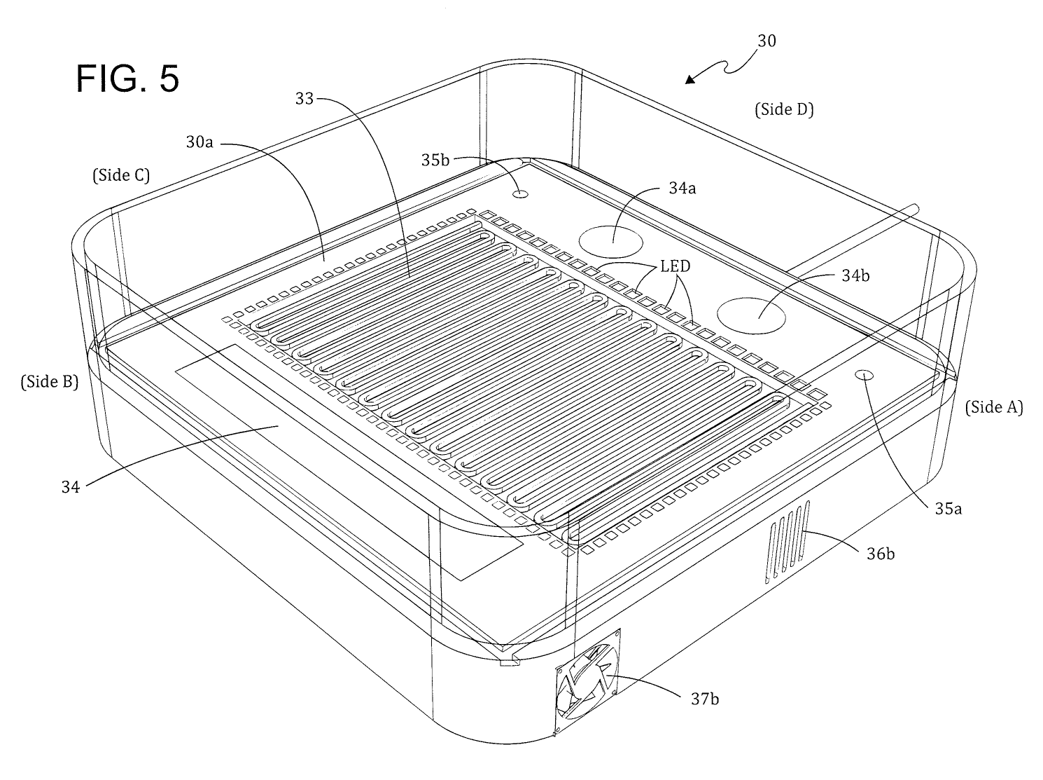

FIG. 5 is a perspective view showing an upper side of a modified version of the base for the aquarium system. In the modified version, the extension pipe for air fog vapor and the fog generator are omitted. Otherwise, the other components are similar as described for the embodiment shown in FIGS. 3 and 4.

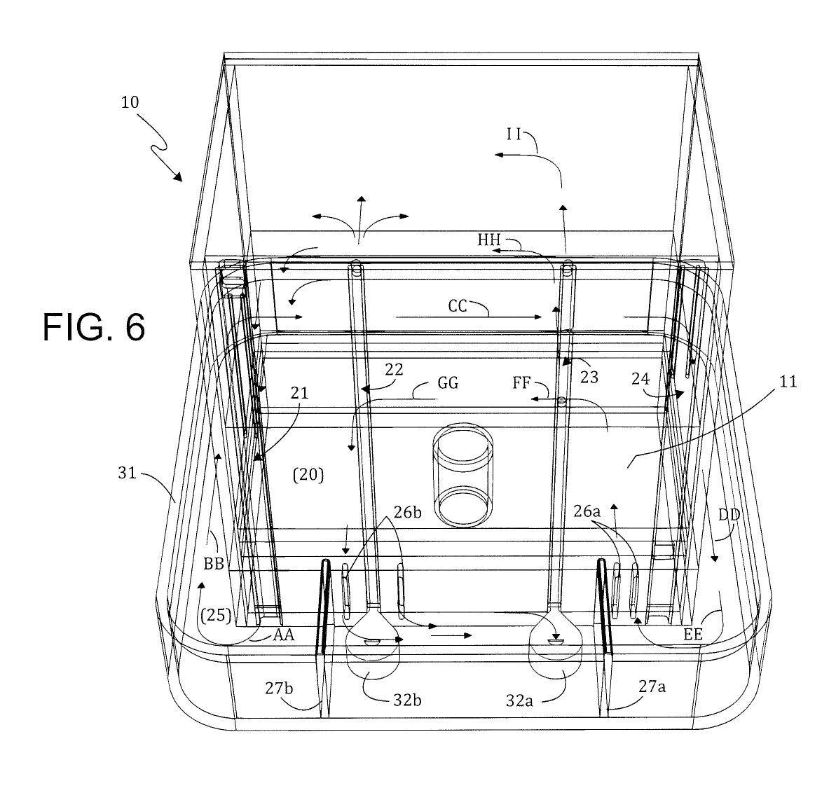

FIG. 6 shows the water circulation flow in the preferred embodiment of the aquarium system. Water flow AA in the tank enclosure 10 is drained through water circulation outlet riser 21 into the outer pool 25. Water flow BB, CC, and DD along the sides of the surrounding pool returns as water flow EE into circulation inlet slots 26a into the sunken chamber 20. Water flow FF and GG into the sunken chamber 20 exits through circulation outlet slots 26b to the outer pool area where the pumps 32a and 32b are positioned. The water filtration module (not shown in this figure) filters the incoming water flow. Pump head 32a pumps water up the water circulation inlet riser 23 for water flow HH and II back into the tank enclosure 10. Pump 32b pumps water up the water spray riser 22 for spraying into the tank 10 as rain (if called for).

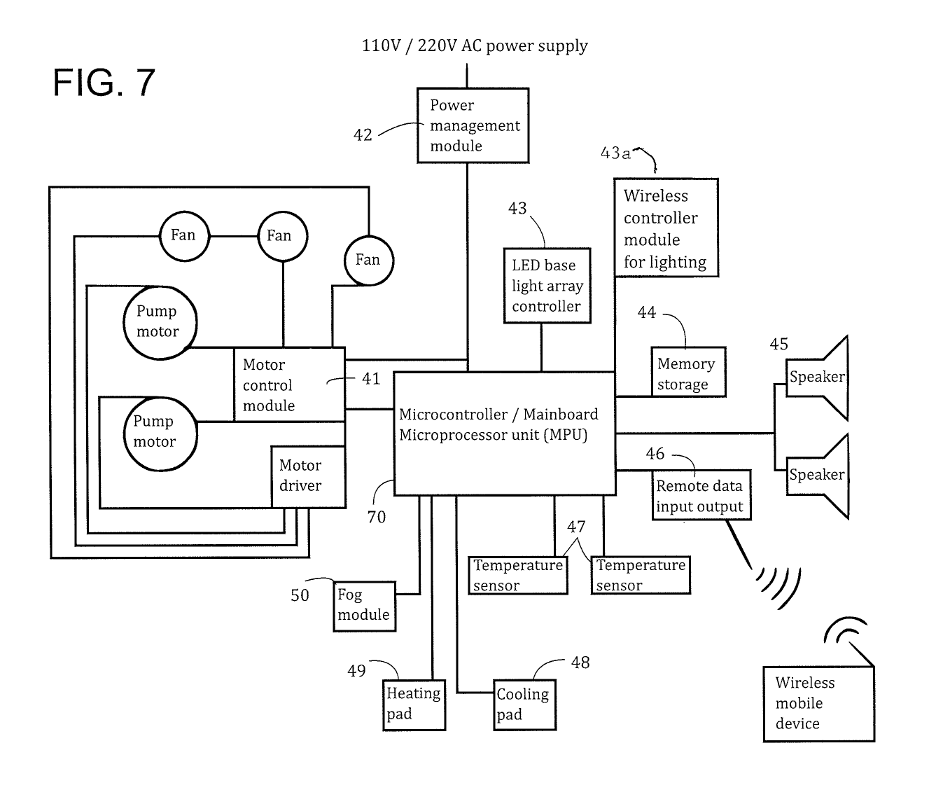

FIG. 7 illustrates a circuit diagram for the electronic components for microclimate simulation in the aquarium system. A microprocessor 70 is provided for programmed computerized control of the components for microclimate simulation, including: a motor control module 41 connected to a driver for the water circulation pump, spray pump, and fans; power management module 42; LED base light array controller 43 and wireless controller 43a (e.g., Bluetooth transmitter) for controlling other lighting elements mounted on or in the top cover; memory storage 44 (e.g., hard drive); audio speaker inputs 45; remote data input 46 (e.g., Bluetooth wireless receiver) to the microprocessor; temperature sensor connectors 47; power control 48 for the cooling pad and 49 for the heating pad; and power control 50 for the fog machine.

A wide range of microclimate simulations can be “performed” by the aquarium system using programmed microprocessor control of the various electronic components for rain, fog, water temperature, lighting, sounds, etc. Microclimate simulations may be “performed” to cause tidal rising or periodic flooding by increasing and decreasing pumped water flow. The water drainage slots may drain at a specific rate. As long as the rate of the pump flow is higher than the drainage rate, the tank water level will rise. The water level may be adjusted by setting the drainage level of the water circulation outlet riser mechanically within the tank, and/or adjusting the pumped water flow rates manually or by microprocessor control.

The calming effect of nature and the aesthetics of nature play a great role in the stress relief and health of human beings. This invention enhances the viewing, range, aesthetics and realism of aquascapes that can be presented. The microclimate device may employ microclimate simulation programs employing the sounds of nature, such as water flowing in a creek, animal or bird calls, and/or sounds that evoke a specific climate or region.

The above-described aquarium system is notable for enabling viewing of aquarium contents and environments from all sides without obstruction. By channeling water flow under the bottom plane of the tank, the user of the aquarium system can greatly reduce the amount of distraction and clutter found in more traditional aquascape tank setups and systems. This allows for a much more direct, undistracted experience with the aquascape art.

Any of a number of stored microclimate simulation programs can be selected by remote data input to the microprocessor and retrieval from memory storage, such as by using a wireless “app” running on a mobile device. Wireless computing devices may include Microsoft Hololens, Apple iPad, Apple iPhone, Android smartphones, tablet is computers, etc. A “real-time weather app” can be created that connects the input to the microprocessor (MPU) in the base via an Internet or wireless connection to a weather website or other climate data source and downloading data for current weather conditions to the microprocessor for simulation in the aquarium system.

Besides the overhead lights on the top cover, an array of light sources may be installed along the path of the vertically seated walls of the tank. The light can travel up through the walls similarly to that of fiber optic technology. By using a mirror like reflector or a curved piece of light conductive material such as optically transparent acrylic, the light can be reflected and/or redirected using the same methods used in fiber optics. Alternatively, an optically transparent cover with built in reflectors on the edges may be used to direct light emitting from the base into the tank and/or pool. Lightning, sunrise, sunset, moonrise, and other lighting effects may be arranged by MPU to match microclimate simulation.

Acrylic plastic may be the preferred material for the tank in that it has light refractive properties that are very close to the light index of refraction properties of water. This allows for a less distorted view of the contents inside the microclimate tank. Acrylic has another benefit in that it is comparably less heat conductive than silica glass. This aids the system by acting as insulation between outside ambient temperatures, and the enclosed climate temperature and conditions. Acrylic is more susceptible to abrasion but scratches may be easily removed with chemicals and maintenance. Silica glass, as a harder material, does not scratch as easily, but once scratched, the scratches may not be removed so easily. Silica glass may be a preferred material for the pool sides and bottom since it is a better heat conductor than acrylic. This would enable water cooling, heating, and temperature sensing to be conducted more effectively from the bottom base.

Aquarium hobbyists sometimes prefer to use frosted glass or even completely opaque color in some aquascaping layouts. Black is a popular one for example, to be used for the back panel of the aquarium. Black and frosted glass that is optically non-transparent may be used for the sides as well. In these cases, the front and top panels of the aquarium are completely optically transparent and the back and even the sides may be black. It may be that these hobbyist options arise from a desire to obscure tubing, pump, and mechanical devices that may be visible in the background. With the provision in the present invention for all-around viewing, the use of black or opaque sides may no longer be necessary. In any event, it is to be understood that the scope of the present invention includes the optional use of frosted, opaque, or colored glass sides. The lack of cluttered overhanging tubing, and ease of maintenance with the usage of the fixed, self contained, built-in risers for filtered water flow into the tank are other advantages in addition to the aesthetic unobstructed line of site view into the tank.

Other options may include partially filling the pool water height below the bottom plane of the tank to leave an air gap above the water surface in the sunken chamber for an airflow space force by an air compression chamber with a fan mounted to it.

Many modifications and variations may of course be devised given the above description of preferred embodiments for implementing the principles in the present disclosure. It is intended that all such modifications and variations be considered as within the spirit and scope of this disclosure, as defined in the following claims.

1. An aquarium system comprising:
a tank enclosure formed with contiguous sides of optically transparent material and a bottom plane for containing a volume of water therein;
a sunken chamber provided below the bottom plane of the tank enclosure for channeling a flow of water circulated from and back into the tank enclosure by a water circulation pump positioned within or adjacent to the sunken chamber;
a water circulation outlet riser for circulating water from the tank enclosure directly or indirectly into the sunken chamber below, and a water circulation inlet riser connected to the water circulation pump for circulation of water back into the tank enclosure above, wherein said water circulation outlet and inlet risers are made of optically transparent material; and
a bottom base on which the sunken chamber and tank enclosure are seated containing therein equipment for powering the water circulation pump positioned within or adjacent to the sunken chamber and other equipment for the aquarium system,
whereby the aquarium system enables viewing of aquarium contents arranged in the tank enclosure from all sides around the tank enclosure without any associated equipment obscuring viewing or otherwise spoiling the viewing aesthetics of the aquarium system.

2. The aquarium system according to claim 1, wherein the sunken chamber is immersed within an outer pool having outer walls and a bottom wall for containing a pool of water surrounding the sunken chamber.

3. The aquarium system according to claim 2, wherein water in the outer pool is maintained at a pool water height below a height position of the bottom plane of the tank enclosure above the sunken chamber.

4. The aquarium system according to claim 1, wherein the water circulation outlet riser has a height-adjustable water level drain slot for adjusting a waterline level in the tank enclosure.

5. The aquarium system according to claim 1, wherein the water circulation inlet riser is spaced apart from the water circulation outlet riser and is connected to the water circulation pump for pumping circulated water from the sunken chamber into the tank enclosure.

6. The aquarium system according to claim 1, wherein a water spray riser has a water spray inlet at its uppermost portion for introducing a water spray to simulate rain in the tank enclosure, and a bottom spray port connected to a water spray pump for pumping water from the sunken chamber into the tank enclosure.

7. The aquarium system according to claim 1, wherein the water circulation pump is of a type driven by magnetic induction of a magnetic induction drive in the bottom base.

8. The aquarium system according to claim 6, wherein the water spray pump is of a type driven by magnetic induction of a magnetic induction drive in the bottom base.

9. The aquarium system according to claim 1, wherein the sunken chamber is formed by lower extensions of the sides of the tank enclosure to a bottom wall of the pool.

10. The aquarium system according to claim 2, wherein a portion of the outer walls of the pool has slots for insertion of a water filtration module in an outer pool area adjacent the water filtration pump.

11. The aquarium system according to claim 10, wherein the water filtration module is adapted to contain biological media and/or activated carbon as water filtration media.

12. The aquarium system according to claim 1, wherein the bottom base has adjustable screws for footpads for adjusting the height and/or angle of incline of the base.

13. The aquarium system according to claim 1, wherein the bottom base contains or supports one or more of the following components for microclimate simulation in the aquarium system:
a) a magnetic induction motor drive positioned in the base proximate the position of the water circulation pump within or adjacent to the sunken chamber.
b) a magnetic induction motor drive positioned in the base proximate a water spray pump within or adjacent to the sunken chamber for pumping a spray of water from the sunken chamber by a riser into the tank enclosure to simulate rain;
c) a cooling pad and heat sink in the base for cooling water in the tank enclosure by thermal contact with an underside of the sunken chamber and/or outer pool;
d) a heating pad in the base for heating water in the tank enclosure by thermal contact with an underside of the sunken chamber and/or outer pool;
e) one or more temperature sensors for sensing the temperature of water in the sunken chamber and/or outer pool;
f) audio speakers positioned on opposite sides of the base for providing audible sounds for simulated environments in the aquarium system;
g) LED lighting elements for transmitting light from the base up the side walls of the tank enclosure to reflectors mounted on or in a top cover;
h) a wireless transmitter in the base for transmitting control signals for controlling other lighting elements arranged in the top cover on the tank enclosure;
i) a fog generator in the base for dispensing air with fog vapor into a fog inlet port into the tank enclosure;
j) a microprocessor in the base for providing programmed computerized control of component facets for microclimate simulation in the aquarium system; and
k) a data input to the microprocessor for selecting a stored microclimate simulation program to be used in the aquarium system and/or for inputting external data via an Internet or wireless connection for microclimate simulation in the aquarium system.

14. The aquarium system according to claim 1, wherein the bottom base contains a microprocessor for providing programmed computerized control of components for microclimate simulation in the aquarium.

15. The aquarium system according to claim 14, wherein the bottom base further includes a data input to the microprocessor for selecting a microclimate simulation to be generated.

16. The aquarium system according to claim 15, wherein the microclimate simulation to be generated is based on selection of a stored microclimate simulation program.

17. The aquarium system according to claim 15, wherein the data input to the microprocessor communicates with a remote data input device such as a wireless application running on a wireless mobile device.

18. The aquarium system according to claim 17, wherein the remote data input device is used to input climate data via an Internet or wireless connection to a weather website or other climate data source for simulation in the aquarium system.

19. An aquarium system comprising:
a tank enclosure formed with contiguous sides of optically transparent material and a bottom plane for containing a volume of water therein;
a bottom base on which the tank enclosure is seated for containing therein equipment for performing a microclimate simulation in the tank enclosure;
a microprocessor in the bottom base for providing programmed computerized control of component facets for performing a microclimate simulation in the tank enclosure,
wherein the bottom base contains one or more of the following components controlled by the microprocessor:
a) a magnetic induction motor drive for a water circulation pump for circulating water in the tank enclosure;
b) a magnetic induction motor drive for a water spray pump to simulate rain in the tank enclosure;
c) a cooling pad and heat sink for cooling the water in the tank enclosure;
d) a heating pad for heating the water in the tank enclosure;
e) one or more temperature sensors for sensing the temperature of the water in the tank enclosure;
f) audio speakers for providing audible sounds for simulated environments in the tank enclosure;
g) LED lighting elements for transmitting light from the base up the side walls of the tank enclosure to reflectors mounted on or in a top cover;
h) a wireless transmitter in the base for transmitting control signals for controlling other lighting elements arranged in the top cover on the tank enclosure; and
i) a fog dispenser for dispensing air with fog vapor into the tank enclosure.

20. The aquarium system according to claim 19, wherein a data input is provided to the microprocessor for selecting a stored microclimate simulation program to be performed in the tank enclosure and/or for inputting external data via an Internet or wireless connection for microclimate simulation in the tank enclosure.
